(19) United States
(12) Patent Application Publication
(10) Pub. No.: US 2006/0156400 A1
(43) Pub. Date: Jul. 13, 2006

(54) System and method for preventing unauthorized access to computer devices

(75) Inventor: Oleksiy Yu. Shevchenko, Kiev (UA)

Correspondence Address: MCDERMOTT WILL & EMERY LLP, 600 13TH STREET, N.W., WASHINGTON, DC, 20005-3096, US

(73) Assignee: GBS LABORATORIES LLC

(21) Appl. No.: 11/029,363

(22) Filed: Jan. 6, 2005

(51) Int. Cl. G06F 12/14

(52) U.S. Cl. 726/22

(57) ABSTRACT

A computer protection system is responsive to incoming data that may be supplied from various data sources for delivery to a protected computer device. The protection system physically isolates the computer device from the incoming data to provide complete protection of the computer device from all possible threats. The protection system has a controller for processing the incoming data to produce output data representing the incoming data. The output data are produced in a form of signal that can be input to a display medium or in a form of instructions on presenting the incoming data on a display medium.

### FIELD OF THE INVENTION

This disclosure relates to data processing systems, and more particularly, to circuitry and methodology for protecting computer devices from unauthorized access.

### BACKGROUND ART

In the past several years, threats in the cyberspace have risen dramatically. With the ever-increasing popularity of the Internet, new challenges face corporate Information System Departments and individual users. Computing environments of corporate computer networks and individual computer devices are now opened to perpetrators capable of damaging local data and systems, misuse the computer systems, or steal proprietary data or programs. The software industry responded with multiple products and technologies to address the challenges.

One way to compromise the security of a computer device is to cause the device to execute software that performs harmful actions on the computer device. For example, an ActiveX control, which is an outgrowth of two Microsoft technologies called OLE (Object Linking and Embedding) and COM (Component Object Model), is a powerful tool for sharing information among different applications. An ActiveX control can be automatically downloaded and executed by a Web browser. Because an ActiveX control is written in a native code it may have full access to the operating system and the process memory in which the ActiveX control is running. However, due to the full access to the operating system, the ActiveX control downloaded from an unknown source on the Internet creates serious security problems. A hostile ActiveX control may steal information from the host system's memory devices, implant a virus, or damage the host system.

There are various types of security measures that may be used to prevent a computer system from executing harmful software. System administrators may limit the software that a computer system can approach to only software from trusted developers or trusted sources. For example, the sandbox method places restrictions on a code from an unknown source. A trusted code is allowed to have full access to computer system's resources, while the code from an unknown source has only limited access. However, the trusted developer approach does not work when the network includes remote sources that are outside the control of the system administrator. Hence, all remote code is restricted to the same limited source of resources. In addition, software from an unknown source still has access to a local computer system or network and is able to perform harmful actions.

Another approach is to check all software executed by the computer device with a virus checker to detect computer viruses and worms. However, virus checkers search only for specific known types of threats and are not able to detect many methods of using software to tamper with computer's resources.

Further, firewalls may be utilized. A firewall is a program or hardware device that filters the information coming through the Internet connection into a private network or computer system. If an incoming packet of information is flagged by the filters, it is not allowed through. Firewalls use one or more of the following three methods to control traffic flowing in and out of the network.

A firewall may perform packet filtering to analyze incoming data against a set of filters. The firewall searches through each packet of information for an exact match of the text listed in the filter. Packets that make it through the filters are sent to the requesting system and all others are discarded.

Also, a firewall may carry out proxy service to run a server-based application acting on behalf of the client application. Accessing the Internet directly, the client application first submits a request to the proxy server which inspects the request for unsafe or unwanted traffic. Only after this inspection, the proxy server considers forwarding the request to a required destination.

Further, a firewall may perform stateful inspection, where it doesn't examine the contents of each packet but instead compares certain key parts of the packet to a database of trusted information. Information traveling from inside the firewall to the outside is monitored for specific defining characteristics, then incoming information is compared to these characteristics. The firewall looks not only at the IP packets but also inspect the data packet transport protocol header in an attempt to better understand the exact nature of the data exchange. If the comparison yields a reasonable match, the information is allowed through. Otherwise it is discarded.

However, the firewall technologies may miss vital information to correctly interpret the data packets because the underlying protocols are designed for effective data transfer and not for data monitoring and interception. For instance, monitoring based on an individual client application is not supported despite the fact that two identical data packets can have completely different meaning based on the underlying context. As a result, computer viruses or Trojan Horse applications can camouflage data transmission as legitimate traffic.

Further, a firewall is typically placed at the entry point of the protected network to regulate access to that network. However, it cannot protect against unauthorized access within the network by a network's user.

Also, advanced firewall strategies are based on a centralized filter mechanism, where most of the filtering operations are performed at the server. During operation of a typical centralized firewall, a single server might have to do the filtering work for hundreds of PC or workstations. This represents a major bottleneck to overall system performance. In the case of the statewide inspection, performance problems are aggravated because the firewall software needs to duplicate much of the protocol implementation of the client application as well as the transport protocol in order to understand the data flow. Providing a client-based filter does not adequately overcome the disadvantages of centralized filtering.

Accordingly, current methods have had only limited success in addressing cyberspace security problems. None of known computer protection methodologies is able to completely protect local computer's resources from perpetrator's actions. For example, no reliable protection is available against unknown threats. Therefore, it would be desirable to create a computer protection system that physically isolates local computer's resources from data received from an external source, to completely eliminate possible threats.

### SUMMARY OF THE DISCLOSURE

The present disclosure offers novel circuitry and methodology for protecting a computer device. A computer protection system of the present disclosure is responsive to incoming data that may be supplied from various data sources for delivery to the protected computer device. The protection system physically isolates the computer device from the incoming data to provide complete protection of the computer device from all possible threats. The protection system may be external with respect to the computer device.

In accordance with one aspect of the disclosure, the protection system comprises a controller for processing the incoming data to produce output data representing the incoming data. The output data are produced in a form of an input to a display medium. An output circuit is provided for forming a unidirectional path to supply the output data from the controller to the display medium.

For example, the output data produced in a form of a signal displayable by the computer device may be supplied to the computer device and displayed on its monitor.

In accordance with another aspect of the present disclosure, the output data may be produced in a form of instructions on presenting the incoming data on a display medium. In particular, the controller may produce the output data including instructions that can be carried out by the protected computer device to display information representing the incoming data.

In accordance with a further aspect of the disclosure, an input circuit may be provided for forming a unidirectional path to supply the controller with input data that may include information and commands provided by a user of the computer device. For example, the input data may be supplied from an input device connectable to the input circuit.

Based on the input data, the controller may produce response data for responding to information represented by the incoming data. Further, in response to the input data, the controller may produce transmit data to be transmitted to a data sink.

A media interface circuit may provide an interface between a source of the incoming data and the controller. For example, the incoming data may be provided by a communication link connected to data networks such as the Internet.

In accordance with a further aspect of the disclosure, the controller may comprise a memory section for storing pre-loaded program that support processing the incoming data. These programs may correspond to programs used in the computer device for processing the incoming data.

In accordance with another aspect, the present disclosure offers a system and methodology for supporting data communications of a computer device with at least one trusted data source and at least one untrusted data source. Such a system comprises a protection system responsive to the trusted data source and the untrusted data source to isolate the computer device from untrusted data provided by the untrusted data source.

The protection system includes a controller for processing the untrusted data to produce output data representing the untrusted data. The output data are in a form of an input to a display medium, or in a form of instructions to be carried out to display the untrusted data. An output circuit is provided for forming a unidirectional path to supply the output data from the controller to the display medium.

The protection system may comprise a filtering circuit that prevents the untrusted data from being supplied from the protection system to the computer device and/or prevents information from being supplied from the computer device to an untrusted recipient. However, the filtering circuit allows trusted data provided by the trusted data source to pass from the protection system to the computer device, and/or allows information to be supplied from the computer device to a trusted recipient.

The filtering circuit may detect a trust mark in a data packet indicating whether the data packet relates to the trusted data source or the untrusted data source. In particular, the filtering circuit may detect an IP address of a data packet indicating whether the data packet corresponds to the trusted data source or the untrusted data source.

In accordance with a further aspect, the present disclosure offers a computer system that comprises a computer device, and a protection system for protecting the computer device from unauthorized access. The protection system is connectable to a source of data to be delivered to the computer device to prevent these data from being supplied to the computer device.

In accordance with another aspect, the present disclosure offers a data communications network comprising a computer device for providing data communications with at least one trusted data source and at least one untrusted data source, and a protection system connectable to the trusted data source and the untrusted data source to prevent untrusted data provided by the untrusted data source from being supplied to the computer device.

In accordance with a method of the present disclosure, the following steps may be carried out to protect a computer device:

preventing incoming data addressed to the computer device from being supplied to the computer device,

supplying the incoming data to the protection device,

processing the incoming data to produce output data representing the incoming data, and

supplying the output data to the computer device for displaying information representing the incoming data.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 is a diagram illustrating a computer protection system of the present disclosure.

FIG. 2 is a diagram illustrating a central controller of the computer protection system.

FIG. 3 is a diagram illustrating a computer protection system of the present disclosure in a computer network.

### DETAILED DISCLOSURE OF THE EMBODIMENTS

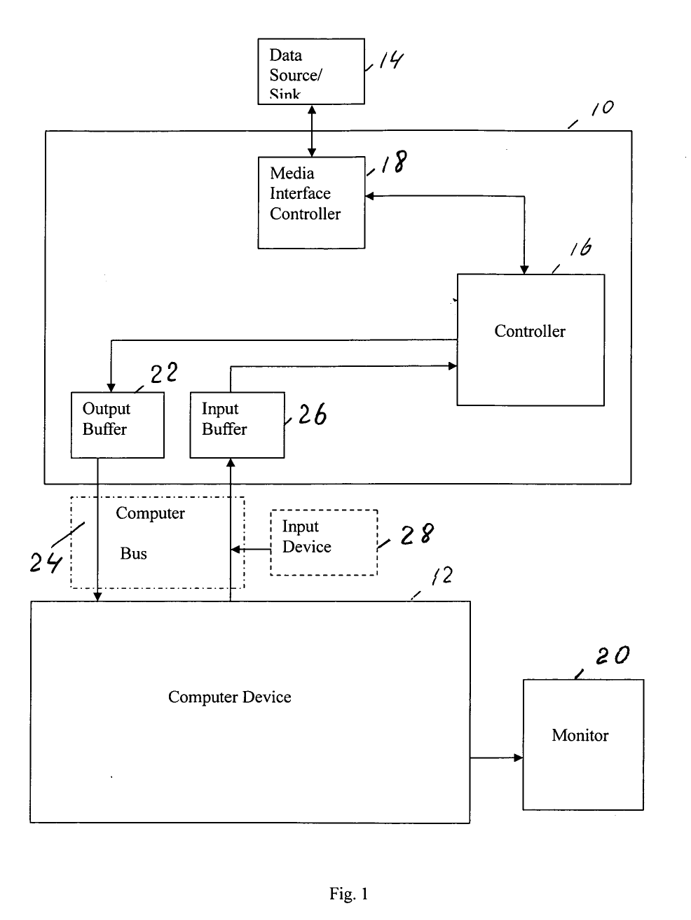

Referring to FIG. 1, a computer protection system 10 of the present disclosure is coupled between a protected computer device 12, and a data source/sink 14 that supplies incoming data intended for or addressed to the computer device 12 and/or receive information representing outgoing data from the computer device 12. The data source/sink 14 may be any source and/or recipient of data, such as a network link coupled via a two-way data communication coupling to the protection system 10. For example, local-area network (LAN) connection, wireless connection, Universal Serial Bus (USB), cable connection, broadband or dial-up telephone line connection, satellite communication link, etc. may be used for transmitting the incoming data for the computer device 12 and receiving the outgoing data from the computer device 12. In any such implementation, the data source/sink 14 sends and/or receives electrical, electromagnetic or optical signals that carry digital data streams representing various types of information.

The data source/sink 14 may provide data communication through one or more networks to other data devices. For example, the data source/sink 14 may provide a connection through a local network to a host computer or to data equipment operated by an Internet Service Provider (ISP). The ISP in turn provides data communication services through the world wide packet data communication network commonly referred to as the Internet. The signals through the data source/sink 14, which carry the digital data to and from the protection system 10, are exemplary forms of carrier waves transporting the information.

The protection system 10 can send and receive messages and data, including program code, through the data source/sink 14, and network link(s). In the Internet example, a server might transmit a requested code for an application program through Internet, ISP, local network and the data source/sink 14. The received code may be executed by the protection system 10 as it is received, and/or stored in a storage device for later execution.

Alternatively, the data source/sink 14 may be any data processing device for supplying and/or receiving data to/from the computer device 12. For example, the protection system 10 may be utilized for protecting the computer device from threats generated by storage devices connectable to the computer device 12.

The computer protection system 10 includes a central controller 16 coupled to the data source/sink 16 via a media interface controller 18, which may be implemented using any interface supporting device for supporting a media interface to the computer protection device 10. For example, the media interface controller 18 may be an Ethernet adapter, cable or DSL modem, dial-up modem, wireless LAN adapter, USB controller, Fireware controller, etc.

As discussed in more detail below, the central controller 16 processes the incoming data from the data source/sink 14 to produce output data representing the incoming data. The output data may be in a form of a signal that can be input to a display medium, such as a monitor 20, capable of presenting information to a user of the computer device 12. For example, the monitor 20 may be integrated into the computer device 12, or coupled to that computer device. Further, the monitor 20 may be integrated into the protection system 10 or coupled to that system. Alternatively, the output data may be produced by the central controller 16 in a form of instructions to be carried out by the computer device 10 or any other data processing device to display information representing the incoming data on the monitor 20 or any other display medium.

The output data from the central controller 16 are supplied to an output buffer 22 that provides a unidirectional path for transferring data including codes or instructions to the computer device. The output buffer 22 may be any hardware and/or software mechanism for providing a one-way transfer of data from the central controller 16 to the computer device 12. These data may be supplied via a computer bus 24 linking the computer device 12 with the protection system 10. For example, a PCI or USB computer bus may be utilized as the computer bus 24.

An input buffer 26 is coupled to the central controller 16 to provide a unidirectional path for transferring input information and commands supplied by a user of the computer device 12 to the central controller 16. The input buffer 26 may be any hardware and/or software mechanism for providing a one-way transfer of input information and commands to the computer protection system 10. One or more input devices 28 may be coupled to the computer bus 12 to communicate the input information and commands to the protection system 10. For example, the input device 28 may have a keyboard including alphanumeric and other keys. Another example of the input device 28 is a pointing device such as an electronic mouse, trackball, light pen, thumb wheel, digitizing tablet, touch sensitive pad, etc., for communicating direction information and commands to the central controller 16 and for controlling cursor movement on the monitor 20 via the central controller 16

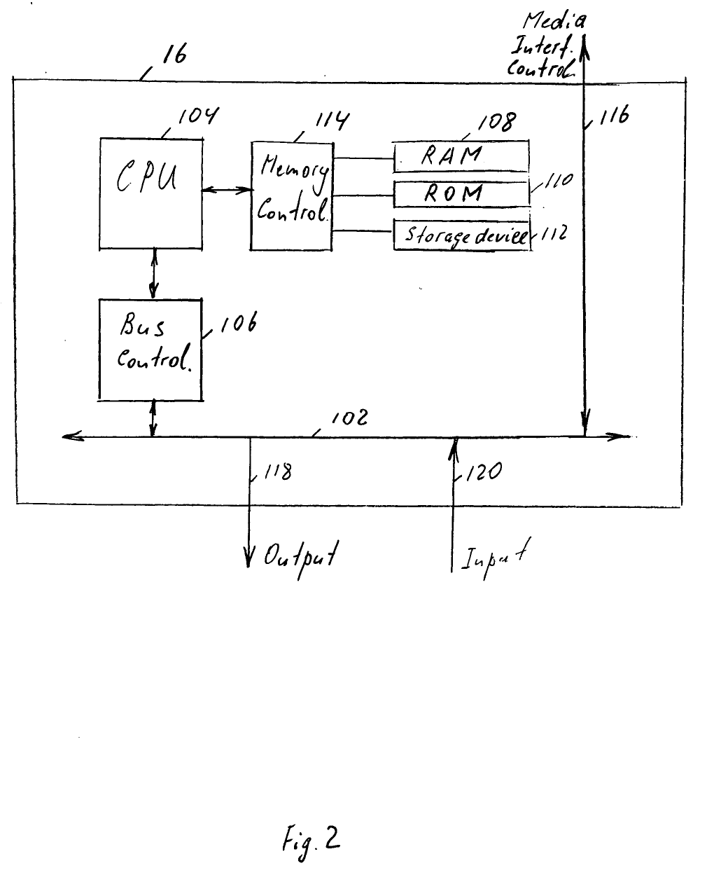

As shown in FIG. 2, the central controller 16 includes a bus 102 or other communication mechanism for communicating information, and a central processing unit (CPU) 104 coupled to the bus 102 via a bus controller 106. The central controller 16 also includes a random access memory (RAM) 108 or other dynamic storage device for storing information and instructions to be executed by the CPU 104. The RAM memory 108 also may be used for storing temporary variables or other intermediate information during execution of instructions to be executed by the CPU 104. The central controller 16 further includes a read only memory (ROM) 110 or other static storage device for storing static information and instructions for the CPU 104. A storage device 112, such as a magnetic disk or optical disk, may also be provided for storing information and instructions. A memory controller 114 may be provided for supporting interactions between the CPU 104 and the memory devices 108, 110 and 112.

Network-related programs of the computer device 12, such as an Internet browser, e-mail and news programs are pre-loaded into one or more memory devices of the central controller 16 to enable the CPU 104 to process data received from the media interface controller 18 via a media interface control bus 116. Hence, instead of handling incoming data in the computer device 12, these data are processed by the CPU 104 which produces output data representing the incoming data from the data source/sink 14. The output data may be in a form of any signal that can be used as an input for a display medium such as a monitor. As one skilled in the art of data processing would realize, such a signal may be produced by a graphics card or video card, or by circuitry integrated into the motherboard. For example, the output data may be produced in a format that satisfies display standards of the monitor 20 in order to enable a user of the computer device 12 to present the output data on the monitor 20.

Alternatively, the CPU 104 may produce the output data in a form of instructions to be carried out by the computer device 10 or any other data processing device to display information representing the incoming data on the monitor 20 or any other display medium.

Via the bus controller 106, the bus 102, and the output bus 118, the output data are supplied to the output buffer 22 that provides a mechanism for one-way transferring the output data to the computer device 12 to present the output data on the monitor 20. Alternatively, the output data may be transferred directly to the monitor 20, or to any other data processing device capable of presenting the output data on a display medium.

Hence, the memory resources of the computer device 12 are completely isolated from the incoming data supplied by the data source/sink 14. Instead of being supplied to the computer device 12, the incoming data are provided to the protection system 10 which presents the incoming data in a form completely free from any possible threats. Further, the one-way mechanism for transferring the output data to the computer device 12 provides a complete protection from transferring any data stored in the computer device 12 to the data source/sink 14.

The input buffer 26 provides a mechanism for one-way transferring data from the computer device 12. In particular, the input device 28 enables a user of a computer device 12 to enter data or commands transferred to the CPU 104 via the input buffer 26, the input bus 120, the bus 102 and the bus controller 106. These input data and commands allow the user to control the network-related applications run by the CPU 104, such as an Internet browser, e-mail or news program, and interact with these applications. For example, the user may enter site addresses, fill in webforms, etc. The input data and commands entered using the input device 28 may be displayed on the monitor 20 or any other display medium.

Also, the input buffer mechanism enables the user to transmit data to the data source/sink 14, and to any network or Internet destination. In particular, based on the input data from the input device 28, the CPU 104 may form data files or other data sequences. For example, e-mail messages may be formed. In addition, the input device 28 enables the user to provide commands for further processing the data files or data sequences, and transmitting them to the data source/sink 14 via the bus controller 106, the bus 102, the media interface control bus 116, and the media interface controller 18.

While the one-way input buffer transfer mechanism allows the user to transmit information from the input device 28, access to data stored in the computer device 12 remains blocked. As no information is transmitted from memory resources of the computer device 12, the stored data are prevented from being transferred to the data source/sink 14. As a result, even if a virus, such as the Trojan horse, or spyware is already planted in the computer device 12 to request sending information from the computer device 12 to an external recipient, the protection system 10 prevents the computer device 12 from sending the requested information. A data transfer enabling mechanism may be provided for enabling a user to transfer a data file or data sequence stored in the computer device 12 to the data source/sink 14. However, such data transfer would be carried out under complete user's control to avoid compromising computer security.

Hence, the protection system 10 of the present disclosure prevents data stored in the computer device 12 from being accessed from outside of the computer device 12. Also, the protection system 10 does not allow the computer device 12 to access the data source/sink 14. As a result, any malicious software code such as computer viruses, worms, Trojan horses, spyware, etc., is not able to penetrate the computer device 12 and cause data stored therein to be sent outside of the computer device 12.

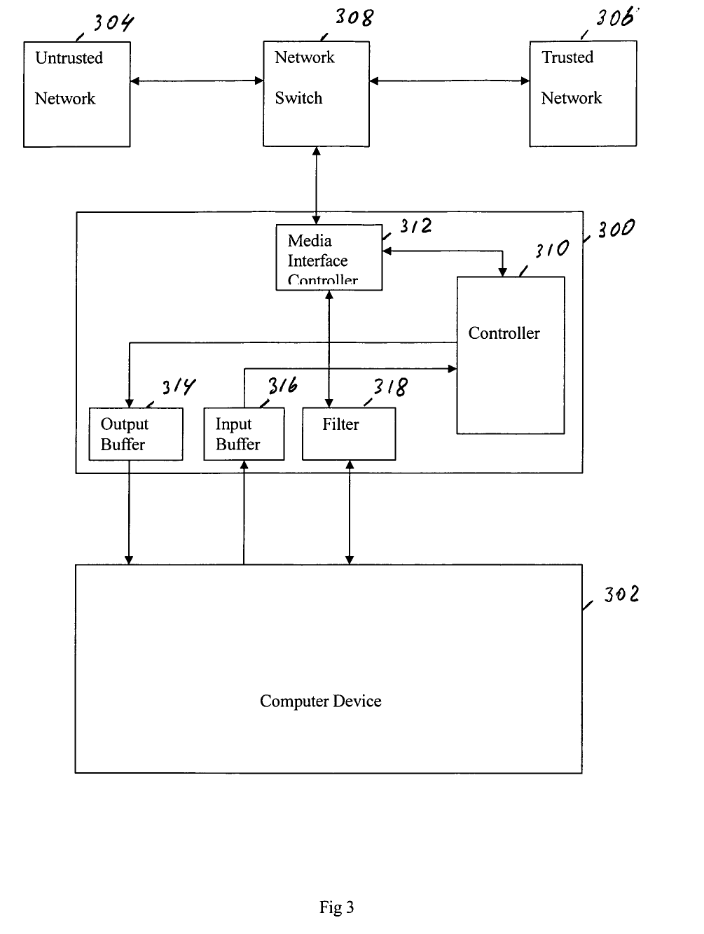

FIG. 3 shows another embodiment of the present disclosure, in which a computer protection system 300 is provided to protect a computer device 302 connected with other computer devices in a computer network, such as a local area network (LAN). Although FIG. 3 shows only a single protected computer device in the network, one skilled in the art will understand that any number of computer devices may be protected.

The computer network may be split into an unsecure or untrusted network segment 304 and a secure or trusted network segment 306. For example, the trusted network segment 306 may include such trusted data sources/sinks as corporate workstations and other resources that may be connected into the corporate Intranet or LAN. The untrusted network segment 304 may include untrusted data sources/sinks such as outside computer networks and the Internet.

A network switch 308, such as a Layer 3 network switch, is provided between the computer protection system 300, the untrusted network segment 304 and the trusted network segment 306. The Layer 3 network switch operates at the Network Layer of the Open Systems Interconnect (OSI) reference model and may provide packet switching, route processing, and intelligent network services. The Layer 3 switch uses network or IP addresses that identify locations on the network to identify network locations as well as physical devices. An identified location can be a network workstation, a location in a computer's memory, or even a different packet of data traveling through the network.

The computer protection device 300 comprises a central controller 310, and a media interface controller 312 coupled between the central controller 310 and the network switch 308. The central controller 310 may have an arrangement similar to the arrangement of the central controller 16 in FIG. 2. The media interface controller 312 supports an interface between the central controller 310 and the network switch 308. Network-related programs of the computer device 12, such as an Internet browser, e-mail and news programs are pre-loaded into a memory of the central controller 310 to enable the controller 310 to process incoming data received from the untrusted network segment 304. The central controller 310 processes the incoming data to produce output data representing the incoming data. The output data may be in a form of a signal that can be input to a display medium such as a monitor. Alternatively, the output data may be in a form of instructions to be carried out by the computer device 302 or any other data processing device to display information representing the incoming data on a monitor or any other display medium.

Also, the computer protection device 300 includes an output buffer 314 that provides one-way transfer of the output data to a monitor of the computer device 302 or any other monitor accessible by a user, and an input buffer 316 that provides a one-way transfer mechanism for supplying the central controller 310 with input data and commands that may be entered using an input device of the computer device 302 or any other input device.

A filter 318 is provided between the computer device 302 and the media interface controller 312 for enabling a data exchange between the trusted network segment 306 and the computer device 302. In particular, the filter 318 detects a prescribed trust mark on a data packet supplied from the media interface controller 312 or from the computer device. The prescribed trust mark indicates whether or not the data packet is originated by the trusted network segment 306 or is addressed to the trusted network segment 306. Data packets having the prescribed trust marks are allowed to pass through the filter 318 to the computer device 302 or to the media interface controller 312. If the filter does not detect the prescribed trust mark on a data packet, the respective data packet is prevented from being supplied from the media interface controller 312 to the computer device 302, or from the computer device 302 to the media interface controller 312.

For example, the filter 318 may detect the IP address of a data packet and determine whether or not this IP address belongs to the trusted network segment 306. If the IP address of a data packet belongs to the trusted network segment 306, the filter 318 allows the respective data packet to be transferred from the media interface controller 312 to the computer device 302, or from the computer device 302 to the media interface controller 312. However, if the IP address of a data packet does not belong to the trusted network segment 306, the filter 318 prevents this data packet from being transferred to the computer device 302, or to the media interface controller 312.

Hence, a bi-direction data exchange between the trusted network segment 306 and the computer device 302 is provided via the filter 318. However, the protection system 300 prevents data from the untrusted network segment 304 from being supplied to the computer device 302, and prevents the data stored in the computer device 302 from being provided to the untrusted network segment 304. Instead, incoming data from the untrusted network segment 304 are directed via the network switch 308 and the media interface controller 312 to the central controller 310 that processes the incoming data to produce the respective output data in a form of a signal that can be input to a monitor of the computer device 302 or any other display medium. Alternatively, the output data may be in a form of instructions to be carried out by the computer device 302 or any other data processing device to display information representing the incoming data on a monitor or any other display medium. The output buffer 314 provides one-way transfer of the output data to the computer device 302 for displaying on the respective monitor.

Further, to communicate with the untrusted network segment 304, a user may utilize an input device coupled to the input buffer 316 to enter input data and commands. The input buffer 316 provides one-way transfer of the input data and commands to the central controller 310. Based on these data and commands, the central controller 310 may form data files or other data sequences for transferring to the untrusted network segment 304.

Hence, while the protection system 300 enables an unrestricted data exchange between computer devices in a trusted network, it provides complete protection of data stored in a corporate network from untrusted access.

Accordingly, a computer protection system of the present disclosure prevents computer viruses, worms, Trojan horses, spyware, etc., from entering a computer.

As the protection system prevents data from an external source from accessing a memory of a protected computer, hackers will not be able to use the software vulnerabilities of the computer device or net protocols—both known or still unknown—to enter the computer.

Further, the protection system prevents hackers from violating local (corporate or home) computer network, even if they know passwords and relevant parameters of the network.

Moreover, the protection system protects inner subnets of a corporate network from inside hackers or attacks.

Further, even if a virus, such as the Trojan horse, or spyware is already planted in a protected computer to request sending information from the computer to an external recipient, the protection system prevents the computer from sending the requested information.

In addition, the protection system enables a computer's user to utilize potentially unsafe software without compromising computer's security.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such or other embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A protection system for protecting a computer device, the system being responsive to incoming data to be provided to the computer device to isolate the computer device from the incoming data, the protection system comprising:
a controller for processing the incoming data to produce output data representing the incoming data, the output data being in a form of an input to a display medium,
an output circuit for providing a first unidirectional path to supply the output data from the controller to the display medium.

2. The system of claim 1, wherein the controller is configured for producing the output data in a form displayable by said computer device.

3. The system of claim 1, further comprising an input circuit for providing a second unidirectional path to supply the controller with input data.

4. The system of claim 3, wherein the input circuit is configured for supplying the controller with the input data provided by an input device.

5. The system of claim 3, wherein the controller is responsive to the input data for producing response data for responding to information represented by the incoming data.

6. The system of claim 3, wherein the controller is responsive to the input data for producing transmit data to be transmitted to a data sink.

7. The system of claim 1, further comprising a media interface circuit for providing an interface between a source of the incoming data and the controller.

8. The system of claim 1, wherein the incoming data are provided by a communication link.

9. The system of claim 1, wherein the protection system is external with respect to the computer device.

10. The system of claim 1, wherein the controller comprises a memory section for storing a program that supports processing the incoming data.

11. The system of claim 10, wherein the program stored in the memory section corresponds to a program used in the computer device for processing the incoming data.

12. A protection system for protecting a computer device, the system being responsive to incoming data to be provided to the computer device to isolate the computer device from the incoming data, the protection system comprising:
a controller for processing the incoming data to produce output data representing the incoming data, the output data being in a form of instructions on presenting the incoming data on a display medium,
an output circuit for providing a first unidirectional path to supply the output data from the controller to the computer device.

13. The system of claim 1, wherein the controller is configured for producing the output data including instructions on displaying by said computer device information representing the incoming data.

14. A system for supporting data communications of a computer device with at least one trusted data source and at least one untrusted data source, comprising:
a protection system responsive to the trusted data source and the untrusted data source to isolate the computer device from untrusted data provided by the untrusted data source, the protection system including:
a controller for processing the untrusted data to produce output data representing the untrusted data,
an output circuit for providing a first unidirectional path to supply the output data from the controller to the computer device for displaying information representing the untrusted data.

15. The system of claim 14, wherein the protection system further comprises a filtering circuit for preventing the untrusted data from being supplied from the protection system to the computer device.

16. The system of claim 15, wherein the filtering circuit is configured for preventing untrusted information from being supplied from the computer device to the protection system.

17. The system of claim 16, wherein the filtering circuit is configured for enabling trusted data provided by the trusted data source to pass from the protection system to the computer device.

18. The system of claim 15, wherein the filtering circuit is configured for detecting a trust mark in a data packet indicating whether the data packet relates to the trusted data source or the untrusted data source.

19. The system of claim 15, wherein the filtering circuit is configured for detecting an IP address of a data packet indicating whether the data packet correspond to the trusted data source or the untrusted data source.

20. A computer system comprising:
a computer device, and
a protection system for protecting the computer device from unauthorized access,
the protection system being connectable to a source of data to be provided to the computer device to prevent said data from being supplied to the computer device,
the protection system including:
a controller for processing the data from the source to produce output data representing the data from the source,
an output circuit for providing a first unidirectional data path to supply the output data from the controller to the computer device for displaying information representing the data from the source, and
an input circuit for providing a second unidirectional data path to supply the controller with input data.

21. A data communications network comprising:
at least one computer device for providing data communications with at least one trusted data source and at least one untrusted data source, and
a protection system responsive to trusted data from the trusted data source and untrusted data from the untrusted data source to isolate the computer device from the untrusted data, the protection system including:
a controller for processing the untrusted data to produce output data representing the untrusted data,
an output circuit for providing a unidirectional path to supply the output data from the controller to the computer device for displaying information representing the untrusted data, and
a filtering circuit for preventing the untrusted data from being supplied from the protection system to the computer device, and for enabling trusted data provided by the trusted data source to pass from the protection system to the computer device.

22. A method of preventing unauthorized access to a computer device, the method comprising the steps of:
preventing incoming data to be delivered to the computer device from being supplied to the computer device,
supplying the incoming data to the protection device,
processing the incoming data to produce output data representing the incoming data, and
supplying the output data to the computer device for displaying information representing the incoming data.
